(19) United States
(12) Patent Application Publication
(10) Pub. No.: US 2015/0142606 A1
(43) Pub. Date: May 21, 2015

(54) SYSTEM AND METHOD FOR RETRIEVAL OF RELATED ITEMS FOR ONLINE AND IN-PERSON SHOPPING THROUGH IMAGE AND CONTEXTUAL INFORMATION ANALYSIS

(71) Applicant: Usman Hafeez, Chicago, IL (US)

(72) Inventor: Usman Hafeez, Chicago, IL (US)

(21) Appl. No.: 14/080,938

(22) Filed: Nov. 15, 2013

(51) Int. Cl. G06Q 30/06; G06K 9/62

(52) U.S. Cl. CPC G06Q 30/0625; G06K 9/6202
USPC 705/26.62

(57) ABSTRACT

The present invention generally relates to computer implemented and web-based systems and methods for retrieving information based on image and contextual information analysis. Specifically, this invention relates to systems and methods for the retrieval of information on related items for online and in-person shopping through image and contextual information analysis.

### FIELD OF THE INVENTION

The present invention generally relates to computer implemented and web-based systems and methods for retrieving information based on image analysis. Specifically, this invention relates to systems and methods for the retrieval of information on related items for online and in-person shopping through image and contextual information analysis.

### BACKGROUND

The use of computing devices, particularly mobile computing devices, to assist with online and in-person shopping has grown exponentially in recent time. Yet, there is currently no way for a user, while shopping in real life, to take an image of a product (such as a dress) and have similar results to the image returned to the user for the purposes of online comparison and shopping. Users currently can snap photos with their mobile devices to do comparison later or pull up browsers to attempt to use text based searches (e.g., red dress, little black dress) for comparison. But currently there is no way to match images taken locally with products available remotely. In addition, currently there is no means to gather additional contextual information, such as the location of the user, the location of like products/services, previous shopping habits of the user, the user's interests gathered from their social network profiles and other sources, the interests of shoppers similar to the user, the actions of the user prior to the capturing of the image, and other similar information that can be gained from the internet or from the user's device, in conjunction with the captured image(s) to assist the user with online and in-person shopping.

Currently, certain providers allow a user to upload an image and find similar images, with websites that the user can go through to find more information, but this requires a multistep process as the user still has to identify the similar images presented by the provider and then perform additional steps to find out and retrieve information about the similar image (e.g., brand name, product name, style, merchant, cost comparison). In addition, the images provided do not take into account the user's interests or interests of similar users to curtail the images displayed, thereby causing the user to have to go through images and information that is not pertinent to the user. There is no automated method for finding and retrieving information about an image, even where the image was analyzed and matched with other like images, in conjunction with contextual information gathered about the user with little to no input required by the user. What is needed is the ability to have image analysis in conjunction with contextual information return the relevant information on item(s) within an image, along with information on comparable items.

Therefore, there is need in the art for computer and web-based systems and methods for providing automated image and contextual information analysis for provision of information related to comparable items matched to the image. These and other features and advantages of the present invention will be explained and will become obvious to one skilled in the art through the summary of the invention that follows.

### SUMMARY OF THE INVENTION

Accordingly, it is an aspect of the present invention to provide a system and method for providing automated image and contextual information analysis for provision of information related to comparable items matched to the image.

According to an embodiment of the present invention, a system for providing automated image and contextual information analysis for provision of information related to comparable items matched to an image includes: an image analysis module, comprising computer-executable code stored in non-volatile memory, an information retrieval module comprising computer-executable code stored in non-volatile memory, a processor, and a communications means, wherein the image analysis module, the information retrieval module, the processor, and the communications means are operably connected and are configured to: receive an image analysis request from a first user; gather contextual information related to said image analysis request; develop an information profile based on the image analysis request and said contextual information; analyze a first image provided in the image analysis request and based at least in part on the information profile; identify one or more items in the first image; retrieve information related to at least one of the one or more items; generate item profiles for one or more of the one or more items; and provide the item profiles to the user.

According to an embodiment of the present invention, the information profile is comprised of one or more of a location, a store identifier, a user profile, a comparable user profile and a user input.

According to an embodiment of the present invention, the location of the user is used in the identification of one or more items by way of eliminating one or more results based on availability of the one or more items within the vicinity of the location.

According to an embodiment of the present invention, each item profile is comprised of one or more of an item manufacturer identifier, item availability report, item price report, comparable item report, comparable item availability report, comparable item price report, complementary item report, complementary item availability report and complementary item price report.

According to an embodiment of the present invention, the item availability report, the comparable item availability report and the complementary item availability report identify availability of one on or more items at locations in the vicinity of the user.

According to an embodiment of the present invention, comparable item price report and the complementary item price report comprise pricing information for one or more items.

According to an embodiment of the present invention, a computer implemented system for providing automated image and contextual information analysis for provision of information related to comparable items matched to an image includes: an image analysis module, comprising computer-executable code stored in non-volatile memory, and a contextual information retrieval module comprising computer-executable code stored in non-volatile memory, wherein the image analysis module and the contextual information retrieval module are operably connected and are configured to: receive an image analysis request from a first user; gather contextual information related to said image analysis request; develop an information profile based on the image analysis request and the contextual information; analyze a first image provided in the image analysis request and based at least in part on the information profile; identify one or more items in the first image; retrieve information related to at least one of the one or more items; generate item profiles for one or more of the one or more items; and provide the item profiles to the user.

According to an embodiment of the present invention, a method for providing automated image and contextual information analysis for provision of information related to comparable items matched to an image, the method comprising the steps of: receiving an image analysis request from a first user; gather contextual information related to said image analysis request; developing an information profile based on the image analysis request and the contextual information; analyzing a first image provided in the image analysis request and based at least in part on the information profile; identifying one or more items in the first image; retrieving information related to at least one of the one or more items; generating item profiles for one or more of the one or more items; and providing the item profiles to the user.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 illustrates a schematic overview of a computing device, in accordance with an embodiment of the present invention;

FIG. 2 illustrates a network schematic of a system, in accordance with an embodiment of the present invention;

FIG. 3 illustrates a network schematic of a system, in accordance with an embodiment of the present invention;

FIG. 4A illustrates a schematic of a system in accordance with an embodiment of the present invention;

FIG. 4B illustrates a schematic of a system in accordance with an embodiment of the present invention;

FIG. 4C illustrates a schematic of a system in accordance with an embodiment of the present invention;

FIG. 5 illustrates a schematic of a system in accordance with an embodiment of the present invention; and

FIG. 6 is a process flow of an exemplary method in accordance with embodiments of the present invention; and

FIG. 7 is a process flow of an exemplary method in accordance with embodiments of the present invention.

### DETAILED SPECIFICATION

The present invention generally relates to computer implemented and web-based systems and methods for retrieving information based on image and contextual information analysis. Specifically, this invention relates to systems and methods for the retrieval of information on related items for online and in-person shopping through image and contextual information analysis. Embodiments of the present invention provide systems and methods are directed to providing users the ability to take a picture of a locally available item and have that picture automatically processed by a computing system which will analyze the picture, analyze contextual information gathered prior to or at the time the picture was taken, identify similar items to those identified in the picture and retrieve information related to the similar items as well as potential availability of alternatives and complimentary items at local merchants, online merchants or other retail locations.

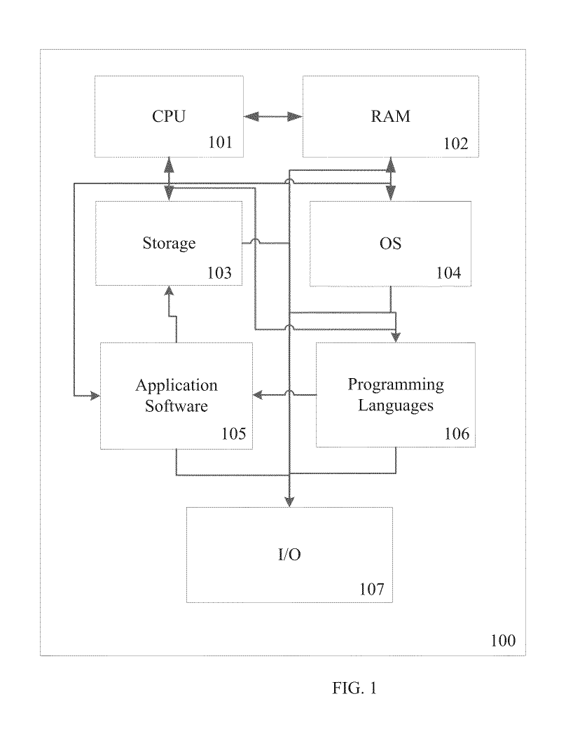

According to an embodiment of the present invention, the system and method is accomplished through the use of one or more computing devices. As shown in FIG. 1, One of ordinary skill in the art would appreciate that a computing device 100 appropriate for use with embodiments of the present application may generally be comprised of one or more of a Central processing Unit (CPU) 101, Random Access Memory (RAM) 102, a storage medium (e.g., hard disk drive, solid state drive, flash memory, cloud storage) 103, an operating system (OS) 104, one or more application software 105, one or more programming languages 106 and one or more input/output devices/means 107. Examples of computing devices usable with embodiments of the present invention include, but are not limited to, personal computers, smart phones, laptops, mobile computing devices and tablet PCs and servers. The term computing device may also describe two or more computing devices communicatively linked in a manner as to distribute and share one or more resources, such as clustered computing devices and server banks/farms. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

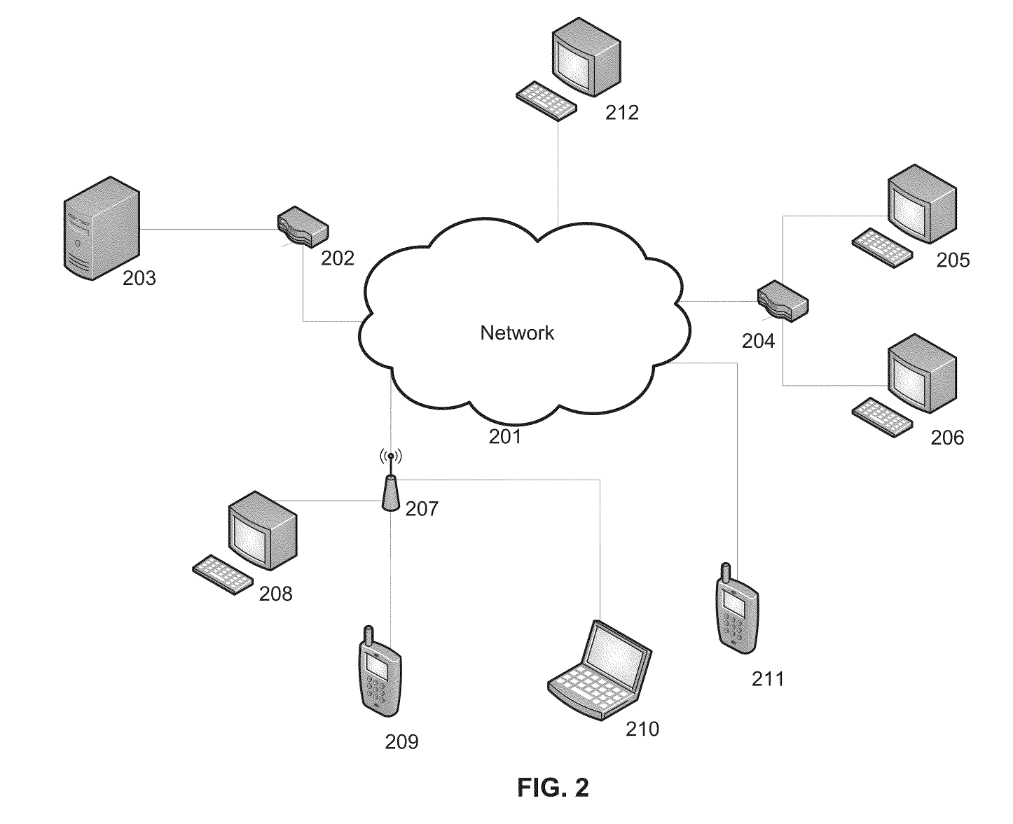

Referring to FIG. 2, a schematic overview of a system in accordance with an embodiment of the present invention is shown. The system is comprised of one or more application servers 203 for electronically storing information used by the system. Applications in the application server 203 may retrieve and manipulate information in storage devices and exchange information through a Network 201 (e.g., the Internet, a LAN, WiFi, Bluetooth, etc.). Applications in server 203 may also be used to manipulate information stored remotely and process and analyze data stored remotely across a Network 201 (e.g., the Internet, a LAN, WiFi, Bluetooth, etc.).

According to an exemplary embodiment, as shown in FIG. 2, exchange of information through the Network 201 may occur through one or more high speed connections. In some cases, high speed connections may be over-the-air (OTA), passed through networked systems, directly connected to one or more Networks 201 or directed through one or more routers 202. Router(s) 202 are completely optional and other embodiments in accordance with the present invention may or may not utilize one or more routers 202. One of ordinary skill in the art would appreciate that there are numerous ways server 203 may connect to Network 201 for the exchange of information, and embodiments of the present invention are contemplated for use with any method for connecting to networks for the purpose of exchanging information. Further, while this application refers to high speed connections, embodiments of the present invention may be utilized with connections of any speed.

Components of the system may connect to server 203 via Network 201 or other network in numerous ways. For instance, a component may connect to the system i) through a computing device 212 directly connected to the Network 201, ii) through a computing device 205, 206 connected to the WAN 201 through a routing device 204, iii) through a computing device 208, 209, 210 connected to a wireless access point 207 or iv) through a computing device 211 via a wireless connection (e.g., CDMA, GMS, 3G, 4G) to the Network 201. One of ordinary skill in the art would appreciate that there are numerous ways that a component may connect to server 203 via Network 201, and embodiments of the present invention are contemplated for use with any method for connecting to server 203 via Network 201. Furthermore, server 203 could be comprised of a personal computing device, such as a smartphone, acting as a host for other computing devices to connect to.

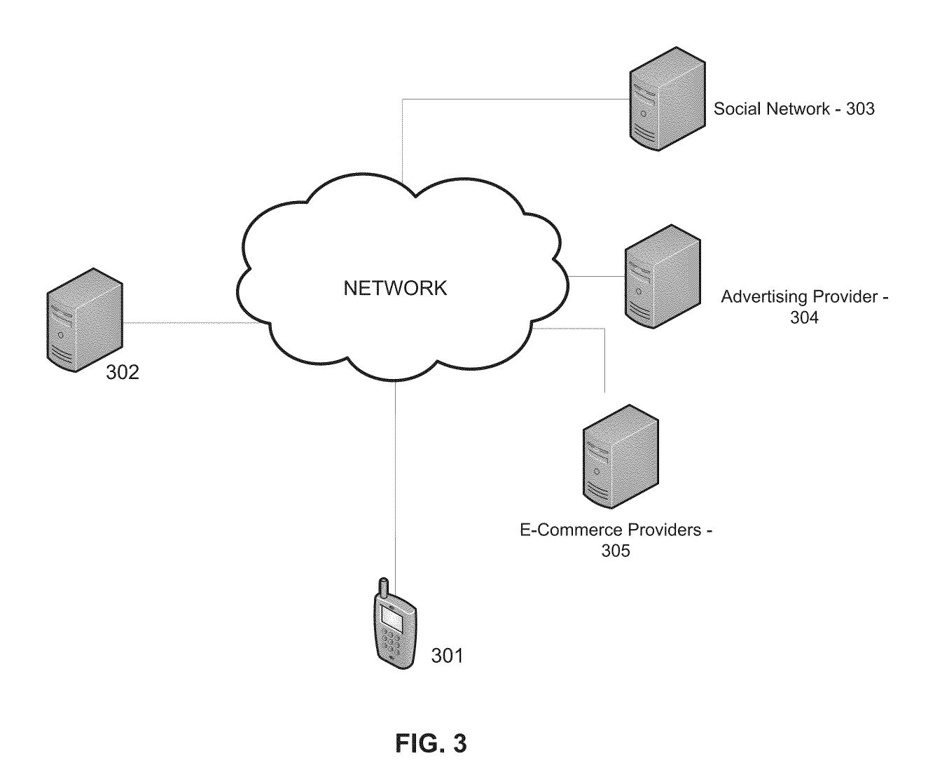

Turning now to FIG. 3, a continued schematic overview of a system in accordance with an embodiment of the present invention is shown. In FIG. 3, the system is shown as it may interact with users and other third party networks or APIs. For instance, a user of a mobile device 301 may be able to connect to application server 302. Application server 302 may be able to enhance or otherwise provide additional services to the user by requesting and receiving information from one or more of a social network 303, an advertising provider API/website or other third party advertising system 304, one or more e-Commerce providers 305 or any combination thereof. One of ordinary skill in the art would appreciate how accessing one or more third-party systems could augment the ability of the system described herein, and embodiments of the present invention are contemplated for use with any third-party system.

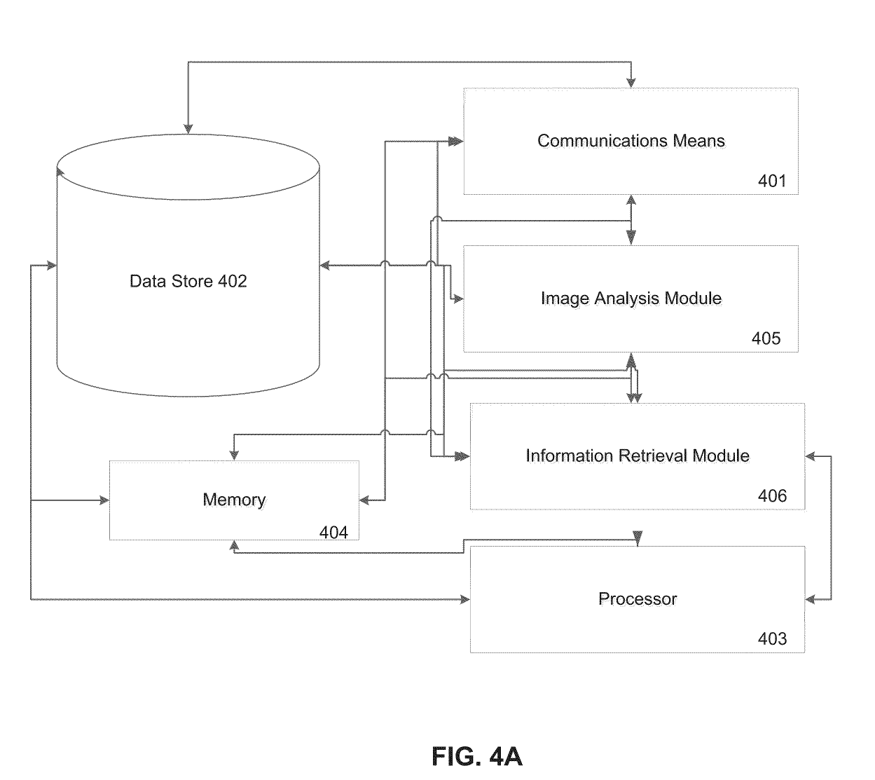

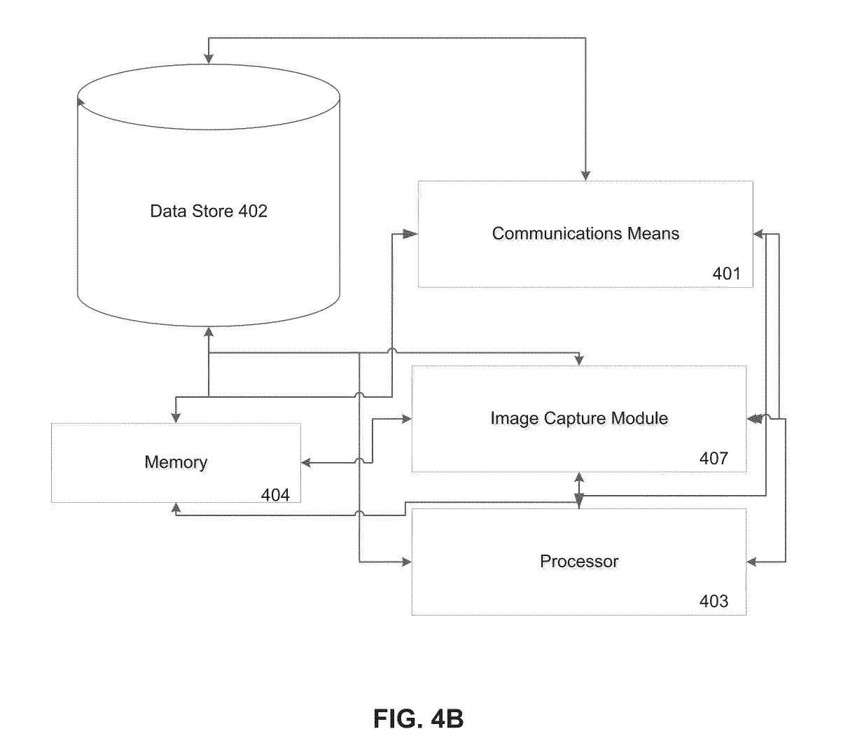

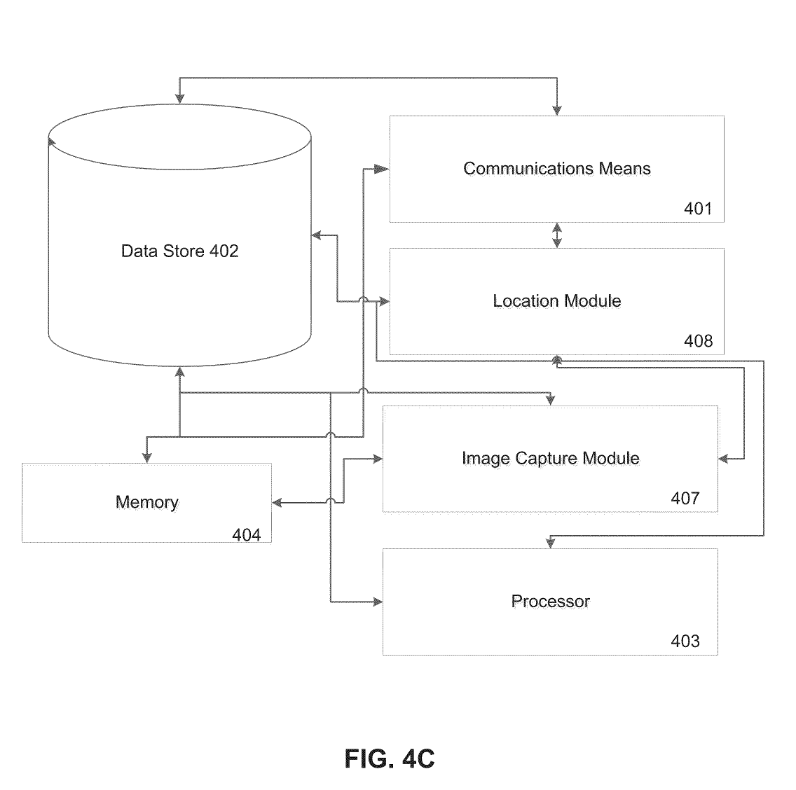

Turning to FIG. 4A, according to an embodiment of the present invention, a system for providing automated image analysis and information retrieval is comprised of one or more communications means 401, one or more data stores 402, a processor 403, memory 404, an image analysis module 405 and an information retrieval module 406. In FIG. 4B, according to an embodiment of the present invention, a component for providing images to the system is comprised of one or more communications means 401, one or more data stores 402, a processor 403, memory 404 and an image capture module 407. In FIG. 4C, according to an embodiment of the present invention, a component for providing images and location information to the system is comprised of one or more communications means 401, one or more data stores 402, a processor 403, memory 404, an image capture module 407 and a location module 408. In a preferred embodiment of the present invention, the components for image analysis and information retrieval may be based on one or more cloud based servers, while the image capture and location components may be located on one or more devices belonging to a user, such as a smartphone or tablet PC. In alternate embodiments, the system may have additional or fewer components. One of ordinary skill in the art would appreciate that the system may be operable with a number of optional components, and embodiments of the present invention are contemplated for use with any such optional component.

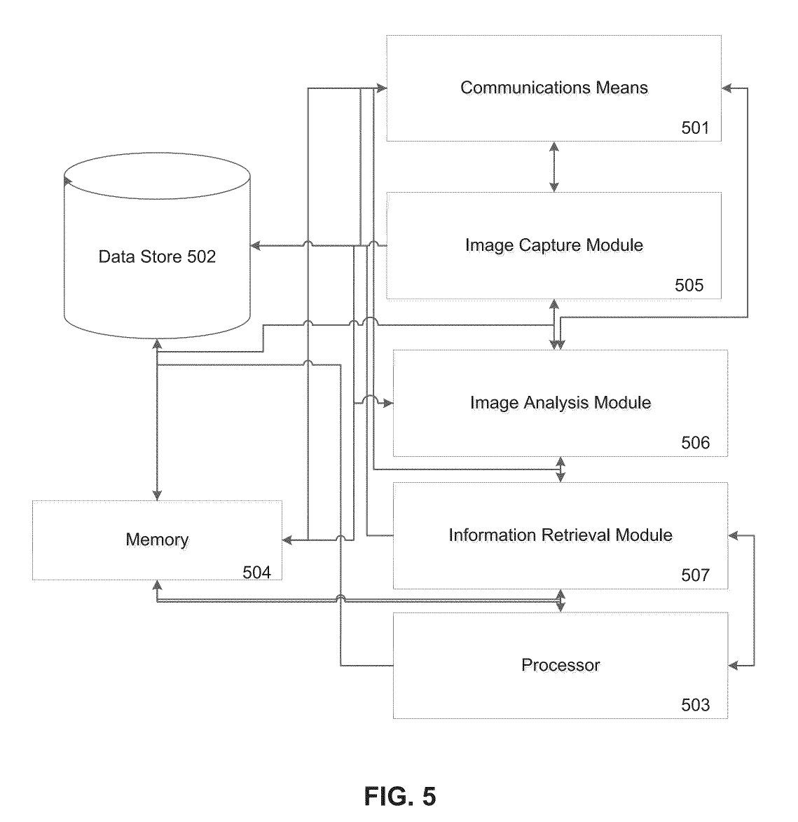

FIG. 5, shows an alternate embodiment of a system for providing automated image analysis and information retrieval, comprised of one or more communications means 501, one or more data stores 502, a processor 503, memory 504, an image capture module 505 an image analysis module 506 and further including an information retrieval module 507. The same embodiments may further include a location module (not numbered) for providing location information. This embodiments represents configurations of the system where the entire hardware and software combination is present on a single device, such as a tablet PC or smartphone. In alternate embodiments, the system may have additional or fewer components. One of ordinary skill in the art would appreciate that the system may be operable with a number of optional components, and embodiments of the present invention are contemplated for use with any such optional component.

According to an embodiment of the present invention, the communications means of the system may be, for instance, any means for communicating data, voice or video communications over one or more networks. Appropriate communications means may include, but are not limited to, wireless connections, wired connections, cellular connections, data port connections, Bluetooth connections, fiber optic connections, modems, network interface cards or any combination thereof. One of ordinary skill in the art would appreciate that there are numerous communications means that may be utilized with embodiments of the present invention, and embodiments of the present invention are contemplated for use with any communications means.

According to an embodiment of the present invention, the location module is configured to provide location based services (LBS) to enhance user experience and functionality. The location module may be configured to utilize location based information provided from the user via one or more location means (e.g., Global position System (GPS), cellular triangulation, IP address location) to provide specific information and services to the user. This LBS information may be utilized by the various other components of the system to enhance content provided by those components (e.g., provide advertising based on user's current location, provide availability of similar products in the vicinity of the user's current location). More information on the utilization of the LBS services in association with the system are detailed later in the specification.

According to an embodiment of the present invention, the image capture module is configured to allow users to capture images to be used in the methods described herein. The image capture module may be one or more of a camera component (e.g., smartphone camera, digital camera, connected image device such as Google® Glass®) an image processing component (e.g., software for processing incoming image data from the camera component) or any combination thereof. In certain embodiments, the image capture module may be separated into two or more physical devices, such as a smartphone or tablet PC and a connected camera component, such as the Google® Glass® or any number of third party cameras that are configured to connect to a computing device via one or more communications means (e.g., Bluetooth, WIFI). One of ordinary skill in the art would appreciate that there are numerous types of image capture modules that could be utilized with embodiments of the present invention, and embodiments of the present invention are contemplated for use with any type of image capture module.

According to an embodiment of the present invention, the image analysis module is configured to provide processing and analysis of images provided to the module. The image analysis module is designed to use image analysis methods known to those in the art in order to identify specific components of the image, especially as may be purposed for the specific intended use of any specific embodiment of the invention and system. In a preferred embodiment of the present invention, the image analysis module may be configured to identify and classify commercial objects present in an image. Commercial objects may include, but are not limited to, items that would be relevant to the consuming public. For instance, commercial objects may include, but are not limited to, clothing, apparel, accessories, toys, electronics, sporting goods, home goods, art, literature, food, makeup, perfumes or any combination thereof. One of ordinary skill in the art would appreciate that there are numerous types of commercial objects that could be utilized with embodiments of the present invention, and embodiments of the present invention are contemplated for use with any commercial object. Further, while preferred embodiments of the present invention may be directed to identifying specifically commercial objects, other embodiments of the present invention may be purposed for classification of non-commercial objects or other objects not detailed specifically herein.

According to an embodiment of the present invention, for the purpose of object identification, the image analysis module may utilize additional contextual information provided by the system or user provided information to help classify and identify objects in the image. The system may be configured to gather the contextual information from an image analysis request from the user, from information stored locally at the system, from third party sources connected to the system, or any combination thereof. For instance, the user's location, as provided by the location module may be utilized to identify a particular item. In an example, the image analysis module may have identified a dress, which it has narrowed down between two very similar dresses, the location of the user, being determined to be a specific store that only sells one of the two dresses, may be utilized to eliminate the second dress that was not provided at the store the user is currently in.

According to an embodiment of the present invention, the information retrieval module is configured to utilize information provided to it via the image analysis module in order to identify relevant information related to not only objects identified in the image, but also to items that may be related to or complimentary to objects identified in the image. The information retrieval module may be configured to utilize any information gleamed from the image analysis module with respect to the items identified, as well as other contextual information that may be provided to the information retrieval module (e.g., location of the user provided by a location module, the user's interests as gathered by the user or the user's social network(s), etc.) in order to retrieve information. More detail is provided below with respect to the information retrieval process and methods for implementation of the information retrieval process.

According to an embodiment of the present invention, the system, and its components, are configured to allow a user to capture an image containing one or more commercial items. The system then utilizes the capture data as basis for its image analysis process, whereby the commercial items are identified on one or more factors. For instance, if an image is captured of a dress, the image analysis process may not only identify the fact that the image is a dress, but also that the dress is of a specific color, a specific cut (e.g., halter top, crew neck, v neck, long sleeve, short sleeve), a specific cut length (e.g, full length, knee length), whether the dress contains identifiable adornments (e.g., zippers, buttons, lace, frill, embroidery), whether a particular designer can be identified (e.g., logo on apparel, label captured in image, image identified through image analysis as belonging to a particular designer).

Once the item has been identified, the system can retrieve information related to the item. Information related to the item includes, but is not limited to, designer or manufacturer of the item, information about the designer or manufacturer, year or season item was first released, where the user can purchase the item (this may be augmented by location information where the user is providing location information, such as via a location module), price and availability at various merchants and stores (e.g., sizes available and color available at each location), reviews of the item by users (e.g., via eCommerce providers or merchants with review systems, via social networks where the user presents a question to their friends or connections on the social network)

Further, in certain embodiments, the information retrieval module may be configured to identify related items and/or complementary items and provide this information to the user who provided the original image. For instance, where the original image was of a dress, the information retrieval module may be configured to retrieve information regarding items that would complement the dress, such as matching accessories (e.g., handbags, jewelry), matching shoes, makeup suggestions that match the dress's colors and potentially matching personal information about the user provided by the system (e.g., the user's skin tone and complexion type).

Further, in certain embodiments, the information retrieval module may be configured to utilize contextual information (e.g. the user's purchase history, the user's stated or assumed interests) to identify related items and/or complementary items and provide this information to the user who provided the original image. For instance, if the user takes a picture of an Armani dress and has purchased Armani products prior to taking the picture, it can be assumed that the user has an interest in Armani products, and similar Armani dresses can be shown, along with Armani belts, shoes, etc.

In certain embodiments of the present invention, the system may be configured to provide complementary items in the form of advertisements, allowing merchants (both local and eCommerce merchants) to pay in order to be listed alongside item information related to identified items. For instance, if the system identifies a complementary item to an item in an image, and the system has an active advertisement for the complimentary item, the advertisement can be displayed with the returned results to the user. In certain embodiments, the display of advertisements may be based, at least in part, on the location of the user as identified by the location module.

### Exemplary Embodiment

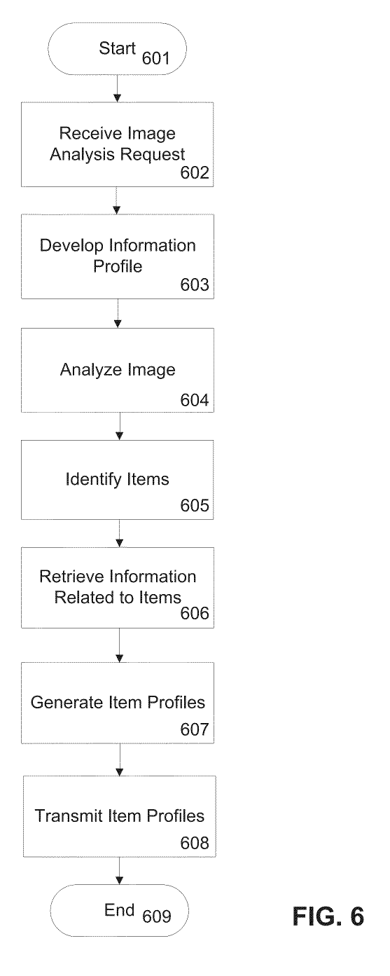

Turning now to FIG. 6, an exemplary method in accordance with an embodiment of the present invention is shown. In this method, the process starts at step 601 with a user interacting with the system. At step 602, the system receives an image analysis request from the user. The image analysis request generally is comprised of a set of information which includes at least one image and any pertinent information provided by the user or the user's computing device about the image. The image generally contains an item that the user wants to identify and have information returned about. The pertinent information may include, but is not limited to, information about the item provided by the user via user input, information about the location of the user provided by the user's computing device (e.g., via the location module), specifics about the user's location (e.g., store name, mall name) or any combination thereof.

At step 603, the system develops an information profile developed from the information provided by the user, including the image that was part of the image analysis request, along with contextual information gathered from one or more of a user input, a device input, or from one or more online sources. In certain embodiments, multiple images may be used as part of the image analysis request, such as various views of a single item. Multiple images may enhance the ability of the system to identify the item as detail provided in separate views may help eliminate otherwise similar items. Similarly, the system may utilize one or more pieces of contextual information in order to enhance the ability of the system to identify the item as the contextual information may help eliminate items based on one or more criteria identified by the system. The information profile generally contains all the information the system needs to process the analysis of the one or more provided images. The information profile may include, but is not limited to a location, a store identifier, a user profile, a comparable user profile, user input, image data and the images themselves. The user profile may be comprised of information about the user that will be useful to the system in processing item information, particularly with respect to comparable and complementary items. The user profile may include, but is not limited to, information related to user's spending patterns and habits, user's shopping preferences, past purchase history, user wardrobe information (e.g., styles and amounts of various articles of clothing and accessories), user's store preference, user's spending limits, user's advertising preferences or any combination thereof. The comparable user profile may comprise of information on the interests of similar users that will be useful to the system in processing item information, particularly with respect to comparable and complementary items. The user profile may include, but is not limited to, information related to user's age, gender, location, spending habits, purchase history, income, marital status, pet ownership, home ownership, ethnicity, or any combination thereof. One of ordinary skill in the art would appreciate that there are numerous points of information that may be utilized with a user profile, and embodiments of the present invention are contemplated for use with any relevant points of information.

In step 604, the system analyzes the image(s). Using image analysis techniques well known in the art, the system is capable of identifying one or more items in the image(s). Some image analysis techniques include, but are not limited to, 2D object recognition, 3D object recognition, image segmentation and 3D pose estimation. One of ordinary skill in the art would appreciate that there are numerous methods for image analysis that could be utilized by embodiments of the present invention, and embodiments of the present invention are contemplated for use with any method of image analysis.

At step 605, the system identifies one or more items in the photo using information provided by the image analysis step. The items may be identified by the image analysis and further filtered based on the information in the information profile (e.g., user location).

Once the items have been appropriately identified by the system, the system sets about retrieving information about the items at step 606. Information may be retrieved locally from one or more databases accessible by the system, retrieved remotely from third party sources available via the Internet or other networked source or any combination thereof. Retrieved item information may include, but is not limited to, item manufacturer, item availability, alternative versions of the same item (e.g., different size, different colors, different cuts, different options), item pricing (including through alternative merchants and online vendors), comparable item reports, comparable item availability reports, comparable item price reports, complementary item reports, complementary item availability reports and complementary item price reports.

A comparable item report is a report generated by the system based on information about items that are comparable to the identified item. For instance, a dress that is made by a different manufacturer than the one identified during the image analysis may be available in the size or color that the user prefers, or at a lower price point than the identified dress or more sold at a more convenient location to the user. The comparable item availability report and comparable item price report are similar in that they provide a report to the user related to the availability of the comparable item(s) and pricing of the comparable item(s).

A complementary item report is a report generated by the system based on information about items that are complementary to the identified item. For instance, the system may be configured to identify accessories that would complement an identified item (e.g., dress). The complementary item availability report and complementary item price report are similar in that they provide a report to the user related to the availability of the complementary item(s) and pricing of the complementary item(s).

At step 607, the system generates one or more item profiles. Item profiles are presentable composites of information to be provided to the user. Item profiles contain the information retrieved about one or more items organized in an appropriate manner. One formed, the system transmits the item profiles to the user at step 608. At this point, the process terminates at step 609.

In an alternate embodiment of the present invention, the method may be altered such that the contextual information gathering and analysis step may be delayed until after the image analysis is completed. The reason for such alteration is that there may be no need for the contextual information analysis if the system is able to identify the item in the image analysis step without the need of any contextual information. In this embodiment, the removal of the contextual information gathering step may decrease overall processing time and system requirements/load.

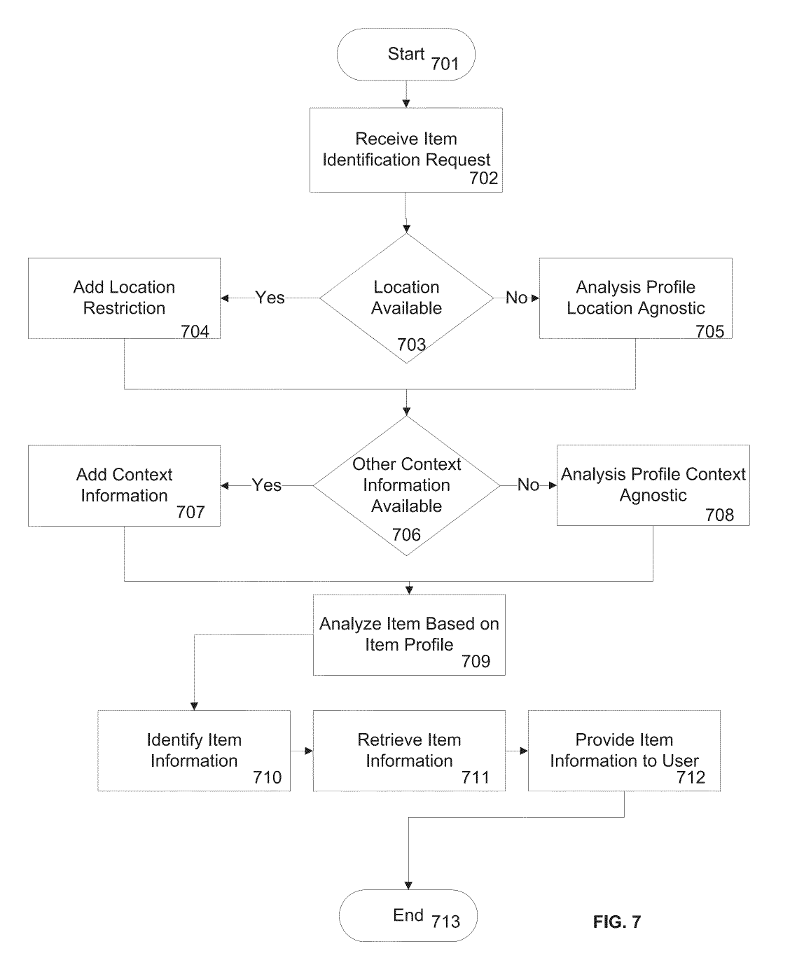

Turning now to FIG. 7, an exemplary method in accordance with an embodiment of the present invention is shown. The process starts at step 701 with a user interacting with the system. At step 702, the system receives an item identification request from the user. The system parses the information and determines if user location information is available (step 703).

If user location information is available, the system includes a location restriction to an item profile (step 704). The location restriction is used to limit item identification to those items available at the user's location. For instance, if a user is at a store belonging to a particular brand, the system can presume that the item to be identified belongs to that particular brand. Where there is no location information provided, the system is agnostic to location (step 705).

The system then parses information related to other contextual information available in the item identification request. Other contextual information may include, but is not limited to, a user profile, a comparable user profile, a user history, information in an image (e.g., product label, barcode) or any combination thereof. Contextual information may be used to help identify the item or limit the scope of analysis of an item based on the contextual information.

If contextual information is available, the system includes it in the item profile (step 707). If no contextual information is available, then the system is agnostic to the context information (step 708).

After forming the item profile, the system analyzes the item based at least in part on the item profile (step 709). Once the item is identified, the system sets about identifying information related to the item (step 710). Item information may be retrieved locally from one or more databases or other data stores, retrieved from third party systems remote from the system and connected via one or more networks, or any combination thereof (step 711).

Once retrieved, the system transmits the information to the user at step 712. The process then terminates at step 713.

Throughout this disclosure and elsewhere, block diagrams and flowchart illustrations depict methods, apparatuses (i.e., systems), and computer program products. Each element of the block diagrams and flowchart illustrations, as well as each respective combination of elements in the block diagrams and flowchart illustrations, illustrates a function of the methods, apparatuses, and computer program products. Any and all such functions (“depicted functions”) can be implemented by computer program instructions; by special-purpose, hardware-based computer systems; by combinations of special purpose hardware and computer instructions; by combinations of general purpose hardware and computer instructions; and so on—any and all of which may be generally referred to herein as a “circuit,” “module,” or “system.”

While the foregoing drawings and description set forth functional aspects of the disclosed systems, no particular arrangement of software for implementing these functional aspects should be inferred from these descriptions unless explicitly stated or otherwise clear from the context.

Each element in flowchart illustrations may depict a step, or group of steps, of a computer-implemented method. Further, each step may contain one or more sub-steps. For the purpose of illustration, these steps (as well as any and all other steps identified and described above) are presented in order. It will be understood that an embodiment can contain an alternate order of the steps adapted to a particular application of a technique disclosed herein. All such variations and modifications are intended to fall within the scope of this disclosure. The depiction and description of steps in any particular order is not intended to exclude embodiments having the steps in a different order, unless required by a particular application, explicitly stated, or otherwise clear from the context.

Traditionally, a computer program consists of a finite sequence of computational instructions or program instructions. It will be appreciated that a programmable apparatus (i.e., computing device) can receive such a computer program and, by processing the computational instructions thereof, produce a further technical effect.

A programmable apparatus includes one or more microprocessors, microcontrollers, embedded microcontrollers, programmable digital signal processors, programmable devices, programmable gate arrays, programmable array logic, memory devices, application specific integrated circuits, or the like, which can be suitably employed or configured to process computer program instructions, execute computer logic, store computer data, and so on. Throughout this disclosure and elsewhere a computer can include any and all suitable combinations of at least one general purpose computer, special-purpose computer, programmable data processing apparatus, processor, processor architecture, and so on.

It will be understood that a computer can include a computer-readable storage medium and that this medium may be internal or external, removable and replaceable, or fixed. It will also be understood that a computer can include a Basic Input/Output System (BIOS), firmware, an operating system, a database, or the like that can include, interface with, or support the software and hardware described herein.

Embodiments of the system as described herein are not limited to applications involving conventional computer programs or programmable apparatuses that run them. It is contemplated, for example, that embodiments of the invention as claimed herein could include an optical computer, quantum computer, analog computer, or the like.

Regardless of the type of computer program or computer involved, a computer program can be loaded onto a computer to produce a particular machine that can perform any and all of the depicted functions. This particular machine provides a means for carrying out any and all of the depicted functions.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

According to an embodiment of the present invention, a data store may be comprised of one or more of a database, file storage system, relational data storage system or any other data system or structure configured to store data, preferably in a relational manner. In a preferred embodiment of the present invention, the data store may be a relational database, working in conjunction with a relational database management system (RDBMS) for receiving, processing and storing data. In the preferred embodiment, the data store may comprise one or more databases for storing information related to the processing of moving information and estimate information as well one or more databases configured for storage and retrieval of moving information and estimate information.

Computer program instructions can be stored in a computer-readable memory capable of directing a computer or other programmable data processing apparatus to function in a particular manner. The instructions stored in the computer-readable memory constitute an article of manufacture including computer-readable instructions for implementing any and all of the depicted functions.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

The elements depicted in flowchart illustrations and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these. All such implementations are within the scope of the present disclosure.

In view of the foregoing, it will now be appreciated that elements of the block diagrams and flowchart illustrations support combinations of means for performing the specified functions, combinations of steps for performing the specified functions, program instruction means for performing the specified functions, and so on.

It will be appreciated that computer program instructions may include computer executable code. A variety of languages for expressing computer program instructions are possible, including without limitation C, C++, Java, JavaScript, assembly language, Lisp, HTML, and so on. Such languages may include assembly languages, hardware description languages, database programming languages, functional programming languages, imperative programming languages, and so on. In some embodiments, computer program instructions can be stored, compiled, or interpreted to run on a computer, a programmable data processing apparatus, a heterogeneous combination of processors or processor architectures, and so on. Without limitation, embodiments of the system as described herein can take the form of web-based computer software, which includes client/server software, software-as-a-service, peer-to-peer software, or the like.

In some embodiments, a computer enables execution of computer program instructions including multiple programs or threads. The multiple programs or threads may be processed more or less simultaneously to enhance utilization of the processor and to facilitate substantially simultaneous functions. By way of implementation, any and all methods, program codes, program instructions, and the like described herein may be implemented in one or more thread. The thread can spawn other threads, which can themselves have assigned priorities associated with them. In some embodiments, a computer can process these threads based on priority or any other order based on instructions provided in the program code.

Unless explicitly stated or otherwise clear from the context, the verbs “execute” and “process” are used interchangeably to indicate execute, process, interpret, compile, assemble, link, load, any and all combinations of the foregoing, or the like. Therefore, embodiments that execute or process computer program instructions, computer-executable code, or the like can suitably act upon the instructions or code in any and all of the ways just described.

The functions and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, embodiments of the invention are not described with reference to any particular programming language. It is appreciated that a variety of programming languages may be used to implement the present teachings as described herein, and any references to specific languages are provided for disclosure of enablement and best mode of embodiments of the invention. Embodiments of the invention are well suited to a wide variety of computer network systems over numerous topologies. Within this field, the configuration and management of large networks include storage devices and computers that are communicatively coupled to dissimilar computers and storage devices over a network, such as the Internet.

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A system for providing automated image and contextual information analysis for provision of information related to comparable items matched to an image, the system comprising:
an image analysis module, comprising computer-executable code stored in non-volatile memory,
a contextual information retrieval module comprising computer-executable code stored in non-volatile memory,
a processor, and
a communications means,
wherein said image analysis module, said information retrieval module, said processor, and said communications means are operably connected and are configured to:
receive an image analysis request from a first user;
gather contextual information related to said image analysis request;
develop an information profile based on said image analysis request and said contextual information;
analyze a first image provided in said image analysis request and based at least in part on said information profile;
identify one or more items in said first image;
retrieve information related to at least one of said one or more items;
generate item profiles for one or more of said one or more items; and
provide said item profiles to said user.

2. The system of claim 1, wherein said information profile is comprised of one or more of a location, a store identifier, a user profile, a comparable user profile and a user input.

3. The system of claim 2, wherein said location is used in said identification of one or more items by way of eliminating one or more results based on availability of said one or more items within the vicinity of said location.

4. The system of claim 1, wherein said each item profile is comprised of one or more of an item manufacturer identifier, item availability report, item price report, comparable item report, comparable item availability report, comparable item price report, complementary item report, complementary item availability report and complementary item price report.

5. The system of claim 4, wherein said item availability report, said comparable item availability report and said complementary item availability report identify availability of one on or more items at locations in the vicinity of the user.

6. The system of claim 4, wherein said item price report, said comparable item price report and said complementary item price report comprise pricing information for one or more items.

7. A computer implemented system for providing automated image and contextual information analysis for provision of information related to comparable items matched to an image, the system comprising:
an image analysis module, comprising computer-executable code stored in non-volatile memory, and
a contextual information retrieval module comprising computer-executable code stored in non-volatile memory,
wherein said image analysis module and said information retrieval module are operably connected and are configured to:
receive an image analysis request from a first user;
gather contextual information related to said image analysis request;
develop an information profile based on said image analysis request and said contextual information;
analyze a first image provided in said image analysis request and based at least in part on said information profile;
identify one or more items in said first image;
retrieve information related to at least one of said one or more items;
generate item profiles for one or more of said one or more items; and
provide said item profiles to said user.

8. The system of claim 7, wherein said information profile is comprised of one or more of a location, a store identifier, a user profile, a comparable user profile and a user input.

9. The system of claim 8, wherein said location is used in said identification of one or more items by way of eliminating one or more results based on availability of said one or more items within the vicinity of said location.

10. The system of claim 7, wherein said each item profile is comprised of one or more of an item manufacturer identifier, item availability report, item price report, comparable item report, comparable item availability report, comparable item price report, complementary item report, complementary item availability report and complementary item price report.

11. The system of claim 10, wherein said item availability report, said comparable item availability report and said complementary item availability report identify availability of one on or more items at locations in the vicinity of the user.

12. The system of claim 10, wherein said item price report, said comparable item price report and said complementary item price report comprise pricing information for one or more items.

13. A method for providing automated image and contextual information analysis for provision of information related to comparable items matched to an image, the method comprising the steps of:
receiving an image analysis request from a first user;
gather contextual information related to said image analysis request;
developing an information profile based on said image analysis request and said contextual information;
analyzing a first image provided in said image analysis request and based at least in part on said information profile;
identifying one or more items in said first image;
retrieving information related to at least one of said one or more items;
generating item profiles for one or more of said one or more items; and
providing said item profiles to said user.

14. The method of claim 13, wherein said information profile is comprised of one or more of a location, a store identifier, a user profile, a comparable user profile and a user input.

15. The method of claim 14, wherein said location is used in said identification of one or more items by way of eliminating one or more results based on availability of said one or more items within the vicinity of said location.

16. The method of claim 13, wherein said each item profile is comprised of one or more of an item manufacturer identifier, item availability report, item price report, comparable item report, comparable item availability report, comparable item price report, complementary item report, complementary item availability report and complementary item price report.

17. The method of claim 16, wherein said item availability report, said comparable item availability report and said complementary item availability report identify availability of one on or more items at locations in the vicinity of the user.

18. The method of claim 16, wherein said item price report, said comparable item price report and said complementary item price report comprise pricing information for one or more items.
